(19) United States
(12) Patent Application Publication
(10) Pub. No.: US 2007/0220817 A1
(43) Pub. Date: Sep. 27, 2007

(54) Storm shield

(76) Inventor: Ronald Scott Bonds, Pasadena, CA (US)

Correspondence Address: Ronald Scott Bonds, 118 Suffolk Avenue, #B, Sierra Madre, CA, 91024, US

(21) Appl. No.: 11/378,409

(22) Filed: Mar. 20, 2006

(51) Int. Cl. E06B 3/26

(52) U.S. Cl. 52/202

(57) ABSTRACT

Storm shield guides air flow and debris contained therein over and around the structure(s) it is shielding; and in so doing takes the force of the air flow and channels it to the ground by the use of ballistic straps and cloth that covers trusses that are connected to concrete and steel foundations. The storm shield also counteracts lift created by high winds as they flow over the structure, and holds the structure down in place.

The invention relates to the use of an anchored, shock absorption shield system that resists and directs high winds and wind-borne debris that occur during severe storm events, particularly hurricanes, tornadoes, and explosive blasts over and around structures being protected and holds down those structures, including but not limited to residential dwellings, commercial structures, industrial structures, government buildings, and vehicles of all types.

Storms such as hurricanes and tornados occur in the United States and through the world on a regular basis, destroying all types of buildings, vehicles, boats, ships. Wind speeds in hurricanes can exceed 180 miles per hour and winds speeds in tornados can exceed 300 hundred miles per hour. Most structures are not usually designed to withstand such wind speeds. In violent storms the tops of buildings, industrial plants, refineries, platforms, vehicles, boats, and ships have shapes similar to the tops of wings, where the air flow over the top of the structure creates lift, just like a wing of an airplane creates lift. Consequently, structures must be held down or they will literally, lift off. The trusses are designed to hold structures down to prevent their lifting up.

Storm shields herein described are shields made of a combination of concrete and steel foundation specifically designed to anchor a metal alloy interconnected truss system that is covered by a combination of materials that will guide wind from any horizontal or vertical direction over the shield, which will absorb a large part of the force of the wind and materials contained therein hitting the shield, protecting the structure(s) or vehicle(s) behind and or beneath it.

The base of storm shields are their foundations (anchors) which anchor the trusses to the ground, separate from the structure(s) being shielded. The anchors are very important because they secure the trusses and do not allow the force of the wind to lift or move the storm shield thereby protecting the structure underneath, keeping it in place.

Anchors are concrete and steel foundations that are constructed prior to the time hurricanes or tornados arrive. The anchors serve to act as a weight to hold the truss system down during those times when the wind may get under the truss system and lift the shield upwards. The anchors also serve as a conduit by which the energy of the wind from a hurricane or tornado is transferred to the ground underneath truss system, pushing down on the truss system onto the anchors.

The hurricane shield works by using a series of triangular shaped trusses and or air-filled tubes that comprise a shield system. Trusses are anchored to the ground in order to transfer the multi-directional forces of hurricanes and tornados to vertical forces, transferring the force of the blast or wind onto the anchors and into the ground. Using Newton's third law “For every action, there is an equal and opposite reaction”, since the winds are pushing down on the truss system the truss system is pushing the wind upwards over the shield like a wing, protecting anything behind and or beneath the shield from storm winds; and the shock absorbing materials and devices divert and deflect materials and debris contained in the wind, thereby protecting anything behind and or beneath the shield.

This invention contemplates the use of a sloped, layered approach to shielding structures from high winds and objects contained therein. The basis is shielding structures by building a triangular structure (shield) that is separated from the structure by a small distance that is anchored to the ground by its own foundation in such a manner that transfers the force of wind and objects contained therein to the ground. The triangularly shaped wood, and/or metal, and/or plastic, and/or composite truss structure is interconnected with straps, and is covered with a ballistic-resistant cover. The trusses are anchored to the ground using concrete and steel foundations that are built prior to a storm arriving and that meet stringent testing requirements. The base of the trusses can also serve as a shock absorption system with the use of springs, and/or shock absorbers that connect the trusses to the foundations. The cover may or may not contain shock absorbing materials as well.

The use of this invention allows very large areas with spans of greater than 25 feet to be covered easily. Window groupings, even several stories of a structure, could be shielded. This invention is heavy in weight, but easy to use, is economical, and is capable of dissipating great forces without damage to the structures being shielded.

Heretofore known devices have internal stiffness and rigidity that resists deflection, or bending. It is this stiffness that stops the missile short of the frangible surface being protected. This invention does not have only rigidity but rather has flexibility in combination with rigidity. It also is designed for being installed in advance of a storm, then disassembled and stored after the storm has passed, because it has features including allowing for ease of assembly, disassembly, and storage.

The flexible shield of the invention is placed a distance out from the surface to be protected. An impacting missile stretches the shield until it decelerates to a stop or is deflected. The shield material has a predetermined tensile strength and stretch that makes it suitable for this application.

### BRIEF DESCRIPTION OF THE DRAWINGS

The present invention will be understood and appreciated more fully from the following detailed description, taken in conjunction with the drawings in which:

FIG. 1 is a frontal view of one embodiment of a hurricane proof storm shield. By “hurricane proof” it is meant that the storm shield is built to withstand and be resistant to high winds (e.g., tropical storm level winds up to about 75 mph, hurricane force winds from about 75 mph up to about 150 mph and the like). The storm shield is designed and built with both standardized and or customized dimensions so as to promote ease of assembly, repair, and protection for structures built on down slope, level, or upslope topography. Various applications are intended and contemplated for the storm shield and, these include; single and multi-unit or multi-family homes, as well as apartments, condominiums, support facilities, general offices, medical facilities, light manufacturing, commercial buildings and the like. In a typical construction, the storm shield can include such features as foundation (item labeled “1”), trusses (item labeled “2”), ballistic repellent materials (item labeled “3”), hold-down straps (item labeled “4”), and shock absorbing materials (item labeled “5”).

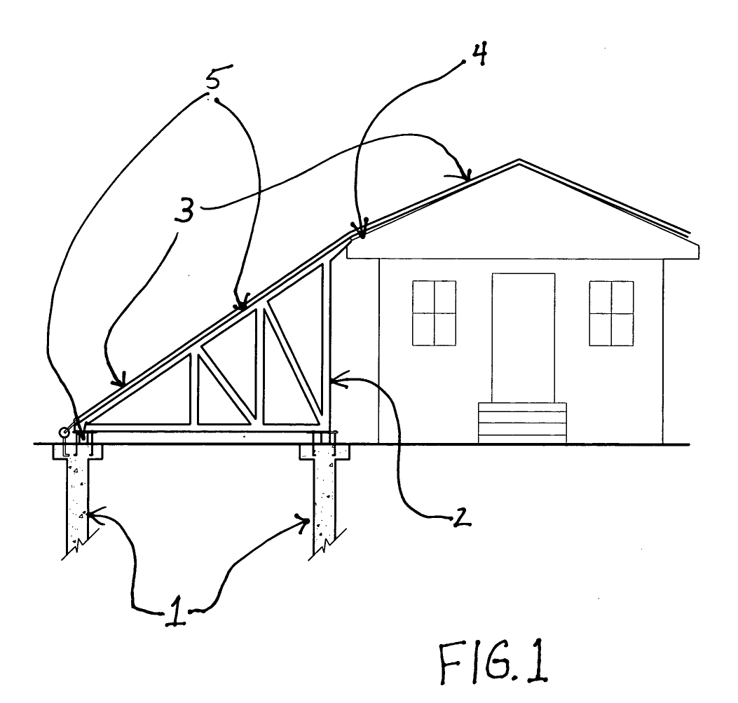

FIG. 2 is a top-down view of trusses surrounding a structure being shielded. The figure shows that the storm shield trusses (item labeled “2”) completely surrounds the structure being protected and is interconnected with hold-down straps (item labeled “4”).

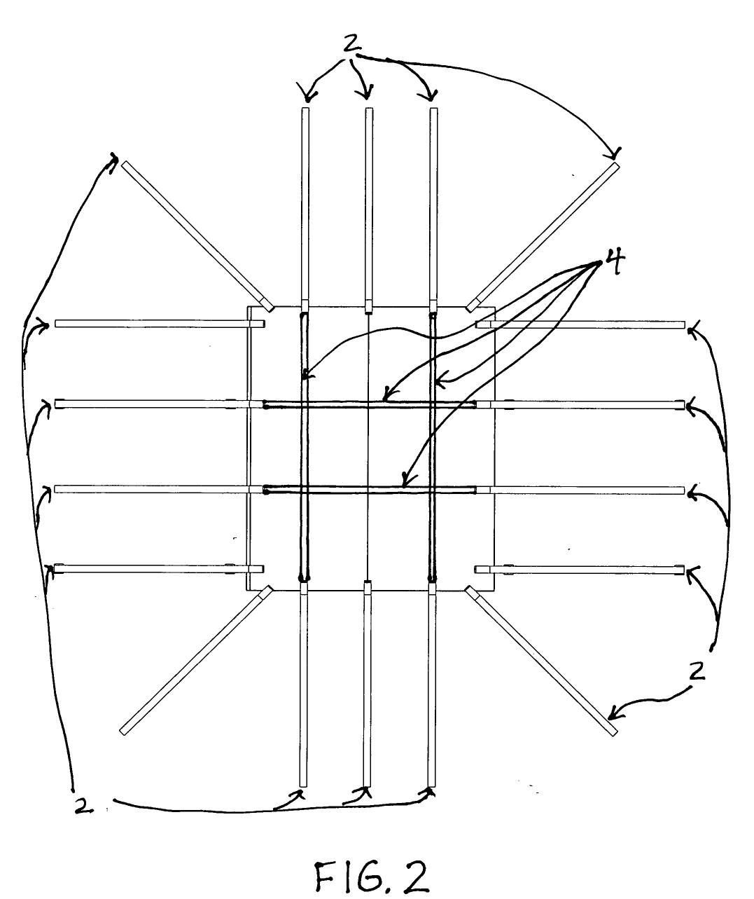

FIG. 2A is a perspective of trusses surrounding a structure being shielded. The figure shows that the storm shield trusses (item labeled “2”) completely surrounds the structure being protected and is interconnected with hold-down straps (item labeled “4”).

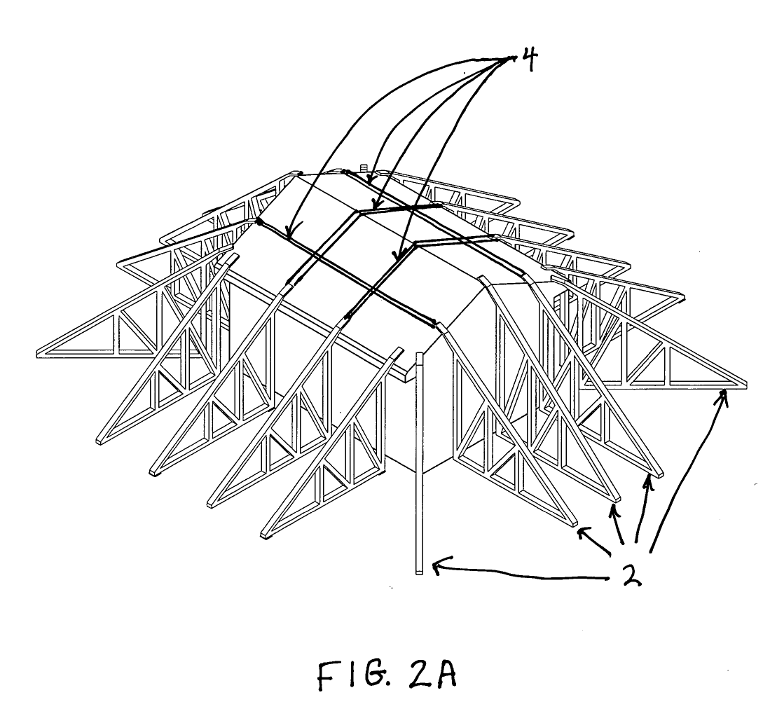

FIG. 3 is a cross-sectional view of a storm shield variation that includes a trussoon layer between the trusses and the cover. It also shows a ridge shieloon, the purpose of which is to absorb shocks of materials hitting the cover over the ridgeline of the structure being shielded.

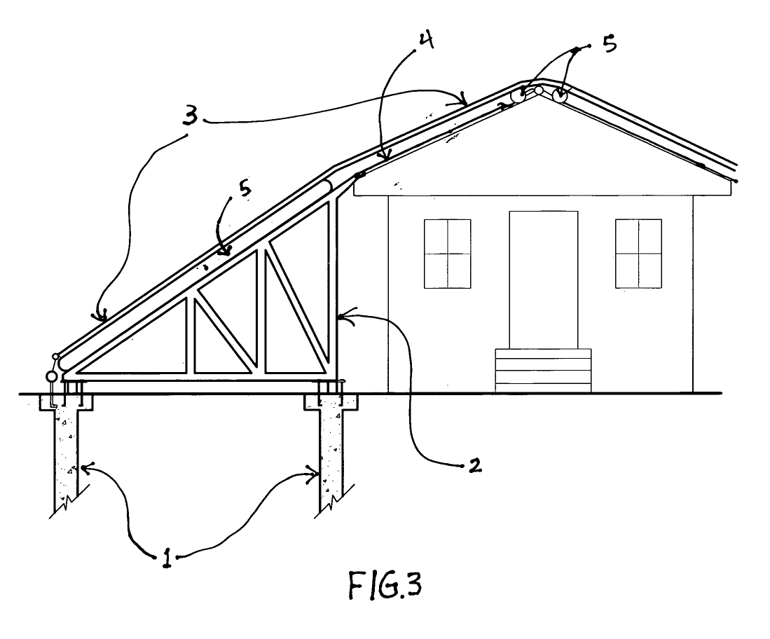

FIG. 4 is a perspective view of one embodiment of a hurricane-proof storm shield according to one aspect of the present invention. The trusses are covered with trussoons, which are covered by ballistic repellent materials. Roofoons are attached to the trusses and over lay the top of the structure being protected up to the shieloon.

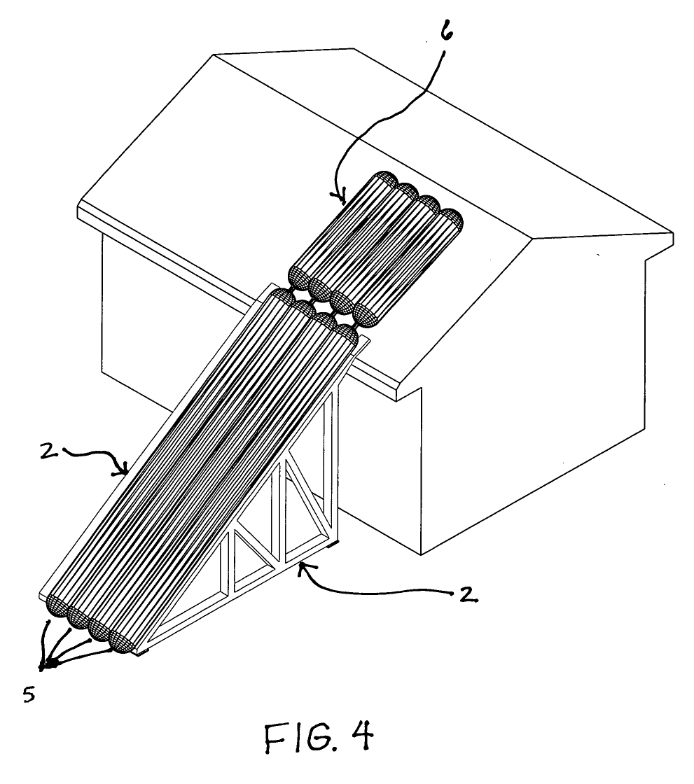

FIG. 5 is a perspective view of one embodiment of a hurricane-proof storm shield according the one aspect of the present invention. The storm shield shown represents a combination of shieloons that surround the protected structure held in place with a hurricane belt and trusses located at the inside corners. The shieloons fill the space under the eaves of the structure when eaves are present. In this embodiment the shieloons are made of ballistic materials. By ballistic materials is meant bullet-resistant type material.

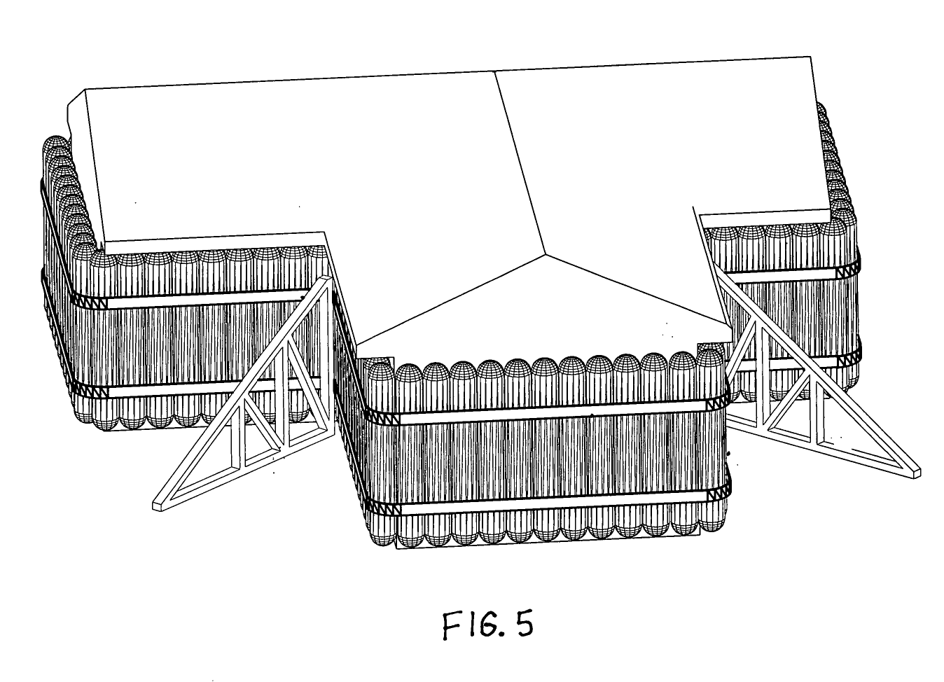

FIG. 6 is a cross-sectional view showing the trussoons covering the vertical walls of a structure. The trussoons are held in place by hurricane belt and covered with a ballistic material held in place by hurricane anchor bolts imbedded in poured concrete foundations. The trussoons are also held in place by carabiners.

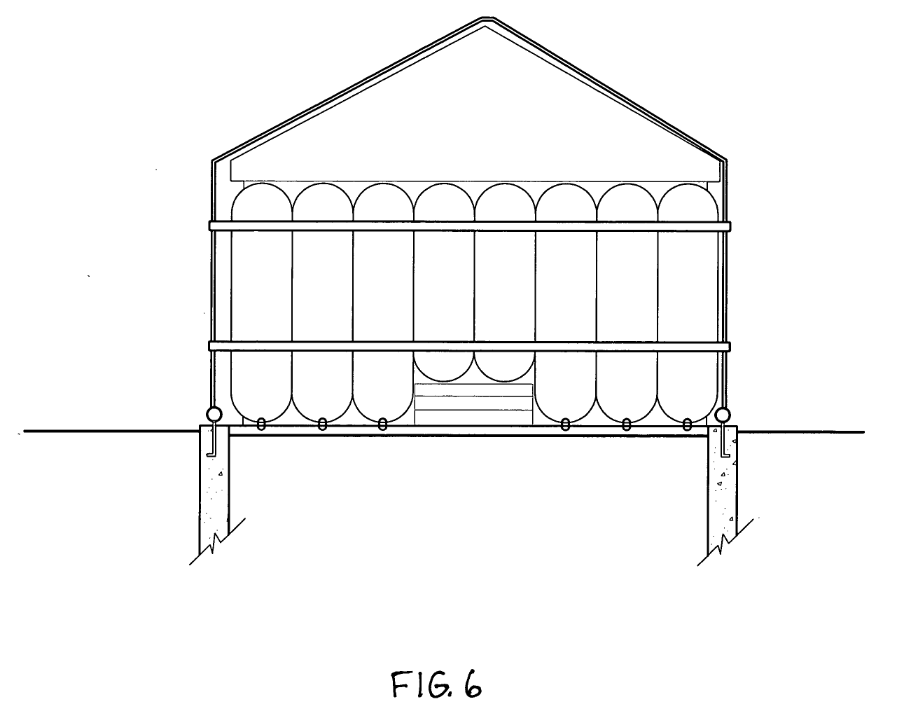

FIG. 7 is a cross-sectional view of one embodiment of a hurricane-proof storm shield according to one aspect of the present invention. In particular, the illustration shows a truss held in place by poured concrete foundations with a air-dam variation. The air dam consists of air-filled ladders that surround the structure held in place by the trusses and sealed to the ground with concrete foundations. The trusses hold and support the air dam vertically and horizontally thereby protecting the structure from what is commonly known as storm surge on a temporary basis.

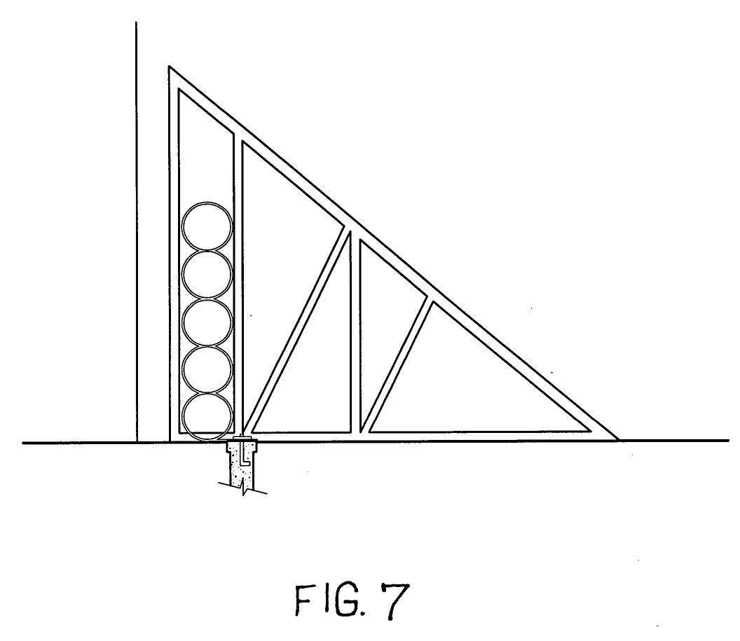

Definition List 1

| Term | Definition |
|---|---|
| Carabiners | Quick release fastener |
| Roofoon | Inflatable tube attached to or on a roof |
| Shieloon | Inflatable tube shielding a wall |
| Trussoon | Inflatable tube attached to or on a truss |

What is claimed is:

1. A combination of materials and structures and comprising: (a) a first layer of a fabric containing high strength fibers wherein the first layer in combination with the underlying materials will deflect in a range from a minimum of 5.0 to 20.0 centimeters employing a 15 pound projectile at a speed of 161 kilometers (100 miles) per hour in accordance with ASTM test procedure E1886-97 mounted on a frame in accordance with FEMA Publication 320, Revision 1 specific to Drawings AG-5 and 14, and/or (b) a second layer of shock absorbing materials and structures with or without (c) a third layer of trusses attached to (d) poured in place concrete and steel anchors or foundations.

2. The composite of claim 1 (a) wherein the deflection is in a range from a minimum of 5.0 to 20.0 centimeters.

3. Where trusses are not needed a combination of sheiloons, and roofoons can be used to cover the structure to channel wind and debris away from the structure. In this case the structure must be strong enough to withstand the force of the wind and debris contained therein in or for the shield to be effective.

4. The trusses will act as a base with their own foundations, which are separate from the foundation of the structure it is protecting. The trusses can act as a base to which devices such as straps and roofoons can be used to hold down the structure and to counteract the lift created by high winds so the structure will not lift off as storm winds flow over the structure.

5. Where there is storm surge is a possibility, such as in low lying areas near levies, or close to a coast, a truss system may include an air-dam, which is a inflatable dam, which is supported by the truss system surrounding the structure.
